(19) United States
(12) Patent Application Publication
(10) Pub. No.: US 2002/0134667 A1
(43) Pub. Date: Sep. 26, 2002

(54) Bioactive device having surface with alloyed layer of calcium phosphate compounds and method of making

(76) Inventors: Thomas D. Driskell, Westerville, OH (US); Arnold H. Deutchman, Columbus, OH (US)

Correspondence Address: John A. Haug, P.O. Box 386, West Harwich, MA, 02671, US

(21) Appl. No.: 10/045,430

(22) Filed: Jan. 11, 2002

Related U.S. Application Data
(60) Provisional application No. 60/261,127, filed on Jan. 16, 2001.

(51) Int. Cl. A61C 8/00; C23C 14/32

(52) U.S. Cl. 204/192.3; 204/192.11; 433/201.1

(57) ABSTRACT

A dental or orthopedic implantable prosthetic device (1) which has a bioactive surface of an alloyed layer of material having calcium phosphate compounds. The device is formed by placing a suitable substrate of biocompatible material in a vacuum chamber (10), the substrate is cleaned by ion beam sputtering (18a) and then ion beam sputtering (14a) evolves and deposits (16a) bioactive material onto the surface of the device. The bioactive layer is mixed into the surface forming an alloyed zone by augmenting ion beam (18a) and is grown out to a selected thickness while being continuously bombarded by the augmenting ion beam.

### CROSS-REFERENCE TO RELATED APPLICATION

Priority is claimed under 35 U.S.C. Section 119 (e)(1) of Prov. Appl. No. 60/261,127, filed Jan. 16, 2001.

### FIELD OF THE INVENTION

This invention relates generally to prosthetic devices including orthopedic; dental and other implantable devices and more particularly, to devices, such as implants, having a surface formed with improved bioactive characteristics.

### BACKGROUND OF THE INVENTION

Plasma sprayed hydroxylapatite (hereafter also identified as HA) coatings have been successfully used clinically since at least the early 1980s to enhance the load transmitting capabilities of orthopedic and dental prosthetic implants placed into bone. Biocompatible materials, such as HA, have a unique attribute compared to most so-called biomaterials in that they are “bioactive” and react compatibly with bone which forms a tenacious bond with HA, a phenomenon commonly known as biointegration. HA also has been demonstrated to enhance the speed of bone healing around implants. From the beginning, however, although widely used clinically, plasma sprayed HA coatings have been subject to a number of physical and biological phenomena that often compromise the health and even survival of the implant. A brief discussion of exemplary problematic areas follows.

### DELAMINATION OF HA COATINGS

The tenacity of the bond between plasma sprayed HA and titanium implant substrates can vary considerably due to processing variables. Even if the bond is good, the coating is still subject to chipping during surgical placement if the surgeon is not careful. Plasma sprayed HA implant surfaces exposed by chipping, or other processes of HA degradation, invariably appear to be grayish-black and rough as if burned.

### SUB-CRESTAL INFECTIONS WITH COMCOMITANT BONE LOSS

Dental implants with plasma sprayed HA coating that extend supra-crestally into the gingival tissue appear to be more subject to infection than uncoated implants and can cause severe crestal bone loss as well as delamination and dissolution of the HA coating. Infection often ensues, usually resulting in rapid degradation and loss of the HA coating in the vicinity of the infected area. These implants sometimes can be saved by reopening the implant site, debriding the infected area and abrading the exposed portions of the implant to remove the remaining supra-crestal HA coating down to a clean, bright titanium surface. If this salvage procedure is not attempted, the implant will probably be lost with a substantial loss of the surrounding bone.

### SUMMARY OF THE INVENTION

It is an object of the invention to overcome the prior art limitations noted above. Another object of the invention is to provide an orthopedic and dental prosthetic implant having improved bioactive characteristics.

Briefly stated, a prosthetic device made in accordance with a preferred embodiment of the invention has a surface formed with improved bioactive characteristics. According to a feature of the invention, an implantable device has a substrate of titanium alloy or other suitable biocompatible material with a layer of inorganic material comprising calcium phosphate containing compounds applied to the surface of the device. A preferred inorganic material for application to the surface is hydroxylapatite (HA). According to another feature of the invention, the layer is bombarded into the substrate using inert ions to form an alloy or intimate mixture of the substrate and inorganic materials. The alloyed surface can be overlaid with an inorganic surface layer continuously bombarded while grown to the alloyed surface, such as an HA surface layer bonded to an apatitic titanium alloyed surface.

### BRIEF DESCRIPTION OF THE DRAWINGS

The accompanying drawings, which are incorporated in and constitute a part of the specification, illustrates preferred embodiments of the invention, and together with the description serve to explain the objects, advantages and the principles of the invention.

FIG. 1 is a schematic view of apparatus used in making a prosthetic device according to the invention,

FIG. 2 is a chart showing the sequence of steps in forming the prosthetic device, and

FIG. 3 is an elevational view of a broken away prosthetic device made in accordance with the invention.

Additional objects and features of the invention will be set forth in part in the description which follows and in part will be obvious from the description. The objects and advantages of the invention may be realized and attained by means of the instrumentalities, combinations and methods particularly pointed out in the appended claims.

### DETAILED DESCRIPTION OF THE PREFERRED EMBODIMENT

In accordance with the invention, an orthopedic or dental prosthetic implant is provided with a surface layer having a bioactive apatitic attribute permitting bone to bond directly and tenaciously to the implant. A preferred substrate material is C.P. titanium or a titanium alloy such as Ti6A14V and an implant made in accordance with the invention has a bioactive apatitic titanium alloy (BATA) surface. However, other biocompatible implant material substrates can be used, such as other metals, ceramic and plastic. Alloy is used in the sense defined in Merriam-Webster's Collegiate Dictionary of a compound, mixture, or union of different things. Application parameters can vary the ratio of HA or other substances imbedded into the surface microstructure of the implant substrate. Further, the alloyed substrate surface, for example apatitic titanium, can be overlaid with an HA surface layer alloyed thereto. It is also within the purview of the invention to alloy other substances, alone or in combination, to alter or otherwise enhance the bioreactive attributes and load transmitting abilities of the implant.

A preferred method of preparation employs a vacuum deposition process. The surfaces of an implant are layered with a thin film of HA by means of a sputtering or any other thin film deposition technique. Concomitantly or sequentially, the HA layered implant surface is bombarded with inert ions, such as argon, by means of a powerful ion beam accelerator device. The HA is impacted into the implant surface with such force by the inert material ions that it is driven into the interstitial spaces present in the microstructure of the implant substrate material, such as titanium. The process parameters are completely controllable. The depth of the apatitic titanium layer can be predetermined and the process additionally allows for an overlay application of an HA layer, preferably between approximately 500 and 10,000 angstroms in thickness, intimately bonded to the underlying apatitic titanium alloy surface if desired. Thus, the HA literally becomes integrated with the implant material. One such process for obtaining the desired surface preparation can be adapted from the processes disclosed in U.S. Pat. No. 5,055,318, the subject matter of which is incorporated herein by this reference. Dimensionally, depth wise, these bioactive surfaces, are measured in angstroms, with a suitable layer extending up to 5000 angstroms into the substrate material. Many types of materials can be alloyed with a variety of substrates using this process or variations of it. For example, a fluoroapatitic titanium surface can be applied if desired. Another modification is to apply the BATA process onto a titanium plasma sprayed (TPS) particulate coated implant surface.

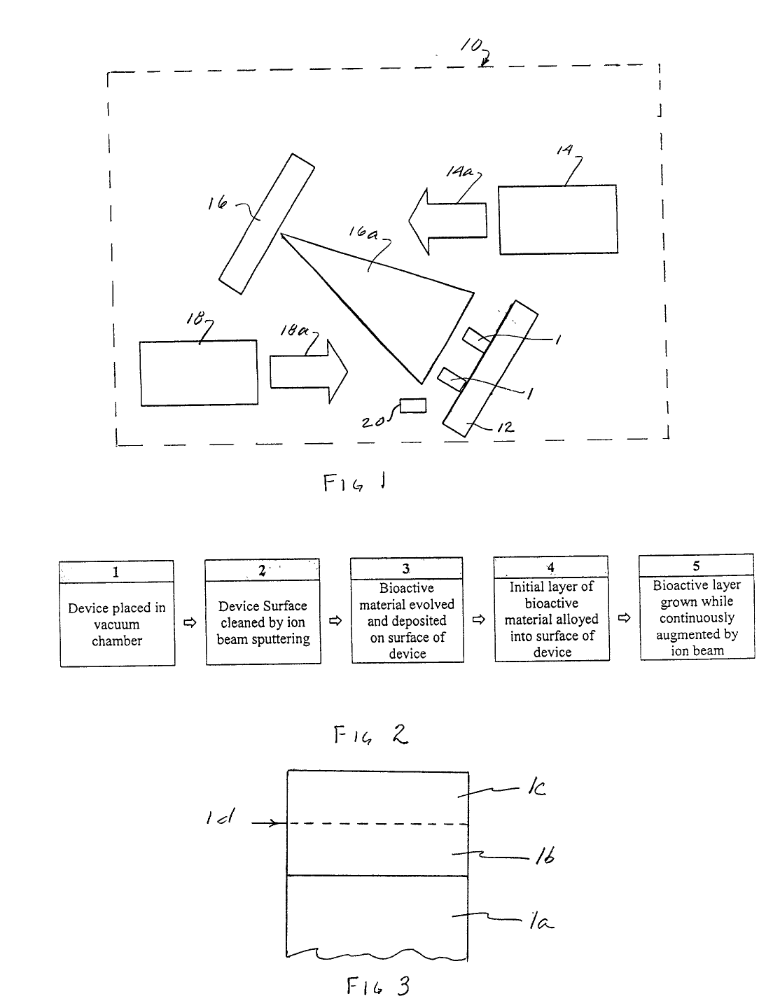

According to the preferred method of forming the improved prosthetic device surface, a dual ion beam process is employed and carried out in a vacuum chamber 10 indicated in a dashed line in FIG. 1. Substrates 1 to be treated are attached to a part platen 12. A sputter ion source 14 directs a sputter beam 14a of inert gas ions toward target platen 16 of bioactive material. Sputtered bioactive material 16a is directed toward devices 1 along with an augmenting inert gas ion beam 18a from augmenting ion source 18. A film thickness sensor 20 allows precise measurement of the thickness of the bioactive layer deposited in and on the surface of the devices.

TABLE I

| Feature | Function |
|---|---|
| Vacuum Chamber | Process is carried out in a high vacuum (allows |
| | control over the quality of the bioactive alloy |
| | formed in and on the surface of the device). |
| Sputter Ion Beam | Inert gas ion beam sputters bioactive material |
| | from the target platen. |
| Target Platen | Bioactive material located on the target platen |
| Part Platen | Devices to be treated attached to the part platen |
| Augmenting Ion Beam | Inert gas ion beam used to first sputter clean the |
| | surface of the devices, next to mix the bioactive |
| | material into the surface of the devices forming |
| | the ballistically alloyed zone, then to control |
| | structure of the bioactive layer as it is grown out |
| | from the ballistically alloyed zone. |
| Film Thickness Sensor | Allows precise measurement of the thickness of |
| | the bioactive alloy layer deposited in and on the |
| | surface of the device. |

As noted above, the bioactive surfaces comprise alloyed layers of calcium phosphate compounds. Table I describes the general dual beam deposition process utilizing the FIG. 1 apparatus and FIG. 2 shows the processing sequence. As shown in FIG. 2, the devices are placed in a vacuum chamber at step 1; the surfaces of the devices are cleaned by ion beam sputtering at step 2; bioactive material is evolved and deposited on the surfaces of the devices at step 3; the initial layer of bioactive material is alloyed into the surface of the devices at step 4; and the bioctive layer is grown and continuously augmented by an ion beam at step 5. In FIG. 3 the device subsurface is shown at 1a and the original surface of the device is indicated in a dashed line at 1d. The bioactive outer layer grown from a ballistically alloyed zone 1b is shown at 1c.

Table II includes specific individual steps in the processing sequence and identifies typical process parameters and ranges of parameters suitable for the process.

TABLE II

| Step | Step Description | Typical Process Parameters | Range of Process Parameters |
|---|---|---|---|
| 1 | Device placed in vacuum chamber on | Vacuum: 1.0E(-07) Torr | Vacuum: 1.0E(-08) to 1.0E(-05) Torr |
| | an articulated fixture which allows | | |
| | programmed orientation of the device | | |
| | during the process. | | |
| 2 | Surface of device cleaned by ion beam | Ion Species: Ar | Ion Species: He, Ne, Ar, Kr, or Xe |
| | sputtering with the ion beam from the | Beam Energy: 500 eV | Beam Energy: (0.1-100) keV |
| | augmenting ion source. | Beam Current: 1.0 mA/cm² | Beam Current (0.01-1500) mA/cm² |
| | | Time: 50 minutes | Time: (0.033-5000) minutes |
| 3 | Sputter ion beam use to ion beam | Ion Species: Ar | Ion Species: He, Ne, Ar, Kr, or Xe |
| | sputter Hydroxylapatite or other | Beam Energy: 1000 eV | Beam Energy: (0.1-100) keV |
| | bioactive material the from target plate | Beam Current: 2.5 mA/cm² | Beam Current (0.1-1500) mA/cm² |
| | onto surface of device. | Material: Hydroxylapatite | Material: Apatitic minerals including |
| | | Evolution Rate: 0.2 Å/sec | calcium and/or phosphorous |
| | | | containing compounds, or fluoride |
| | | | containing compounds including Ca2F |
| | | | Evolution Rate: (0.008-120) Å/sec |
| 4 | Augmenting ion beam used to | Ion Species: Ar | Ion Species: He, Ne, Ar, Kr, or Xe |
| | ballistically alloy first few layers of | Beam Energy: 1000 eV | Beam Energy: (0.1-100) keV |
| | sputtered bioactive material into device | Beam Current: 1.0 mA/cm² | Beam Current (0.1-1500) mA/cm² |
| | surface. | Time: 12 minutes | |
| 5 | Bioactive layer is grown out from the | Ion Species: Ar | Ion Species: He, Ne, Ar, Kr, or Xe |
| | ballistically alloyed layer as ion beam | Beam Energy: 200 eV | Beam Energy: (0.1-100) keV |
| | sputtering of the target continues. | Beam Current: 0.05 mA/cm² | Beam Current (0.01-1500) mA/cm² |
| | Augmenting ion beam used to control | Thickness: 2,000 Å | Thickness: (100-100,000) Å |
| | the structure of the bioactive layer as | | |
| | it is grown. | | |

Tale III includes the Table II steps and step description along with actual parameters for the examples of carrying out the process identified as Run #1 and Run #2, resulting in a coating thickness of 2,265 angstroms for the devices of Run #1 and 2,812 angstroms for the devices of Run #2.

TABLE III

| Step | Step Description | Run #1 | Run #2 |
|---|---|---|---|
| 1 | Device placed in vacuum chamber on | Vacuum: 5.0E(-05) Torr | Vacuum: 7.0E(-05) Torr |
| | an articulated fixture which allows | | |
| | programmed orientation of the device | | |
| | during the process. | | |
| 2 | Surface of device cleaned by ion beam | Ion Species: Ar | Ion Species: Ar |
| | sputtering with the ion beam from the | Beam Energy: 500 eV | Beam Energy: 500 eV |
| | augmenting ion source. | Beam Current: 7.0 mA/cm² | Beam Current: 6.0 mA/cm² |
| | | Time: 50 minutes | Time: 50 minutes |
| 3 | Sputter ion beam use to ion beam | Ion Species: Ar | Ion Species: Ar |
| | sputter Hydroxylapatite or other | Beam Energy: 1000 eV | Beam Energy: 1000 eV |
| | bioactive material the from target plate | Beam Current: 1.0 mA/cm² | Beam Current: 1.0 mA/cm² |
| | onto surface of device. | Material: Hydroxylapatite | Material: Hydroxylapatite |
| | | Evolution Rate: 0.2 Å/sec | Evolution Rate: 0.2 Å/sec |
| 4 | Augmenting ion beam used to | Ion Species: Ar | Ion Species: Ar |
| | ballistically alloy first few layers of | Beam Energy: 1000 eV | Beam Energy: 1000 eV |
| | sputtered bioactive material into device | Beam Current: 1.0 mA/cm² | Beam Current: 1.0 mA/cm² |
| | surface. | Time: 12 minutes | Time: 15 minutes |
| 5 | Bioactive layer is grown out from the | Ion Species: Ar | Ion Species: Ar |
| | ballistically alloyed layer as ion beam | Beam Energy: 200 eV | Beam Energy: 200 eV |
| | sputtering of the target continues. | Beam Current: 0.05 mA/cm² | Beam Current: 0.05 mA/cm² |
| | Augmenting ion beam used to control | Thickness: 2,265 Å | Thickness: 2 813 Å |
| | the structure of the bioactive layer as | | |
| | it is grown. | | |

Virtually all of the previously mentioned problems associated with plasma sprayed HA implants are resolved by the use of the BATA surface technique described above for the following reasons. There is no oxidation or other high temperature deterioration (blackening) of the implant substrate from the BATA process. The previously noted problems are eliminated because no appreciable heat is applied during the BATA surface application process. Delamination or chipping is eliminated due to the alloyed nature of the BATA surface which is integrated into the implant substrate. However, abrasion or other marring of the BATA surface is still possible through careless handling during surgical placement. The clinical significance however, is of no greater importance than the same type of abrasion on a conventional uncoated or TPS coated titanium implant. Preliminary in-vivo studies in dog femurs indicates histologically that advanced healing of surrounding bone abutting the BATA surface test specimens was evident at six weeks when compared to uncoated control specimens when seen at twelve weeks.

Although the invention has been described with regard to specific preferred embodiments thereof, variations and modifications will become apparent to those skilled in the art. For example, additional inorganic material, such as calcium fluoride, can be alloyed into an HA overlayer coating in accordance with the teaching of the invention. It is therefore, the intention that the appended claims be interpreted as broadly as possible in view of the prior art to include all such variations and modifications.

What is claimed:

1. A method of enhancing the bioactivity of a substrate comprising the steps of applying to the surface of the substrate inorganic material comprising calcium phosphate containing compounds using relatively low temperature and bombarding the applied inorganic material into the substrate using inert ions forming an alloy of the substrate material and the inorganic material.

2. A method according to claim 1 in which the inorganic material is applied by sputtering.

3. A method according to claim 2 in which the inorganic material is embedded into the substrate surface a distance of up to 5000 angstroms.

4. A method according to claim 3 in which the substrate is formed of one of C.P. titanium and titanium alloy.

5. A method according to claim 3 in which the substrate is formed of ceramic.

6. A method according to claim 3 in which the substrate is formed of resin.

7. A method according to claim 3 in which the inorganic material is hydroxylapatite.

8. A method according to claim 7 further comprising the step of applying an additional layer of hydroxylapatite to the alloy while continuously bombarding the additional layer with an augmenting ion beam.

9. A method according to claim 8 in which the additional layer of hydroxylapatite is between approximately 500 and 10,000 angstroms thick.

10. An article made according to the method of claim 3.

11. A dental implant made according to the method of claim 4.

12. An orthopedic implant made according to the method of claim 4.
